(19) United States
(12) Patent Application Publication
(10) Pub. No.: US 2026/0359316 A1
(43) Pub. Date: Nov. 12, 2026

(54) Multi-System Data Object Integration with Semantic Mapping

(71) Applicant: ServiceNow, Inc., Santa Clara, CA (US)

(72) Inventor: Sagar Gupta, Bangalore (IN)

(21) Appl. No.: 19/202,930

(22) Filed: May 8, 2025

(51) Int. Cl. G06F 16/25; G06F 16/21

(52) U.S. Cl. CPC G06F 16/254; G06F 16/211

(57) ABSTRACT

An example embodiment may involve: obtaining first representations of database objects and relationships between the database objects, wherein the database objects are associated with a plurality of applications, and wherein each of the database objects is associated with one or more fields; based on mappings between each of the plurality of applications and an integrated schema, writing second representations of the database objects and the relationships to the integrated schema; and populating a searchable knowledge graph including the second representations of the database objects and the relationships.

### BACKGROUND

Modern computing systems often rely on structured data associated with multiple applications, where some of the applications generate corresponding data in a different format and/or arrangement. There are various challenges associated with techniques for integrating data having different formats and/or arrangements. For example, some integration techniques result in data being repeated across multiple entries because these techniques are unable to accurately detect duplicate entries.

Additionally, integrating this data into workflows or into features assisted by artificial intelligence (AI) remains a significant challenge. A lack of accuracy or completeness of such an integration can result in wastage of computational resources (e.g., processor, memory, network, and/or power capacity) as users may have to perform discrete sub-tasks several times before they are able to complete an overall task. Each repetition uses more of these resources. Further, security procedures may be unable to identify vulnerabilities in these computing systems (e.g., misconfigurations, malware, or evidence of unwanted intrusions), leading to exfiltration and/or loss of sensitive data, as well as potential service outages.

### SUMMARY

Various implementations disclosed herein include provide an architecture and procedures for harmonizing data from multiple different sources into an integrated schema. Employing deterministic as well as probabilistic similarity determination techniques, duplicate entries can be detected with a high degree of confidence and merged in the integrated schema. This not only results in smaller databases with less overhead, but also decreased complexity when the integrated database is queried. Additionally, the embodiments herein improve data accuracy, which facilitates increased performance and correctness of workflows, AI-assisted uses, and data security features.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect involves a method. The method includes obtaining first representations of database objects and relationships between the database objects, where the database objects are associated with a plurality of applications, and where each of the database objects is associated with one or more fields. The method also includes based on mappings between each of the plurality of applications and an integrated schema, writing second representations of the database objects and the relationships to the integrated schema. The method also includes populating a searchable knowledge graph including the second representations of the database objects and the relationships. Other embodiments of this aspect include corresponding computer systems, apparatus, and computer programs recorded on one or more computer storage devices, each configured to perform the actions of the method.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a computational instance interactive with applications employing different schemas, in accordance with example embodiments.

FIG. 7 depicts three schemas, each defining a format for storing data related to an individual, in accordance with example embodiments.

FIG. 8 depicts an integrated schema, in accordance with example embodiments.

FIG. 9 depicts a data ingestion and harmonization process, in accordance with example embodiments.

FIGS. 10A, 10B, and 10C depict mappings between schemas, in accordance with example embodiments.

FIGS. 11A and 11B depict pseudocode for transforming values of a field, in accordance with example embodiments.

FIG. 12 depicts an architecture for database harmonization and data retrieval, in accordance with example embodiments.

FIG. 13 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved relates to the difficulties of developing and maintaining software applications that rely on data stored in disparate databases and in accordance with different schemas. In practice, this is problematic because maintaining data across multiple databases with differing schema increases integration complexity. Many unified reports and analytics queries require bespoke extract, transform, and load (ETL) pipelines to reconcile mismatched tables and fields (e.g., to handle missing or extra fields or data formatted in different ways). Also, these pipelines often fail whenever any source schema changes. Moreover, existing integration techniques result in data being duplicated across multiple entries in the integrated schema because these techniques are unable to accurately detect duplicate entries.

The embodiments herein overcome these limitations by employing an architecture and procedures for harmonizing data from multiple different source schema into an integrated schema. This results in several advantages. First, it dramatically simplifies data integration and maintenance. With one unified ETL pipeline instead of many bespoke pipelines, each source schema can be mapped to the integrated schema, so adding new sources or evolving existing ones no longer has a deleterious impact on downstream applications. Second, semantic consistency is enforced centrally so that every entity and attribute has a single, well-defined type, name, and format. Third, memory usage is reduced because the embodiments herein are able to more efficiently and accurately merge duplicate entries from different source databases. This not only results in smaller databases with less overhead, but also decreased complexity when the integrated database is queried. Notably, the embodiments herein reduce the number of in-memory page frames and index entries the database manages, lower the size of intermediate join result sets, and diminish the need for garbage collection in client-side caches. As a result, query execution consumes fewer buffer reads and writes, experiences fewer page faults, and benefits from a smaller, more cache-friendly memory footprint, thus delivering faster lookups and more predictable performance.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

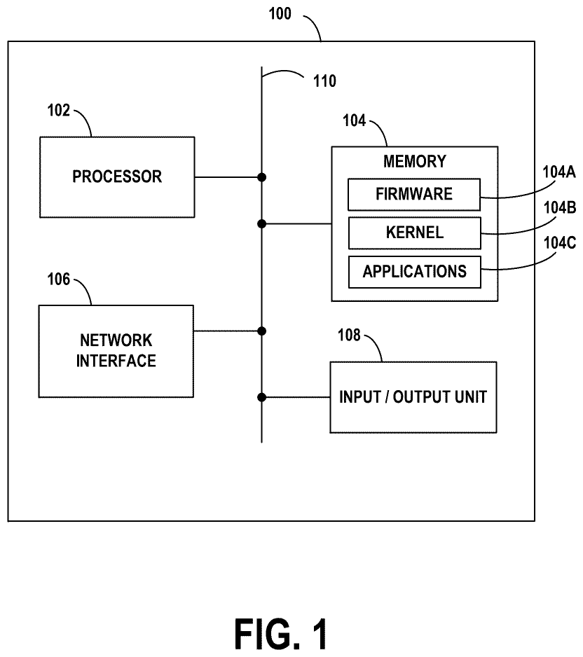

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input / output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

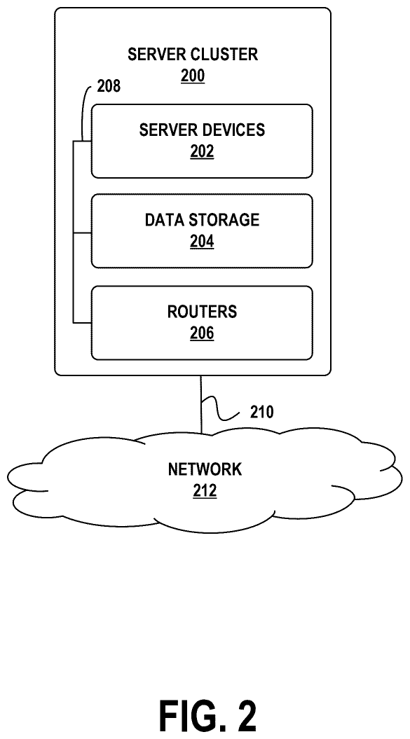

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

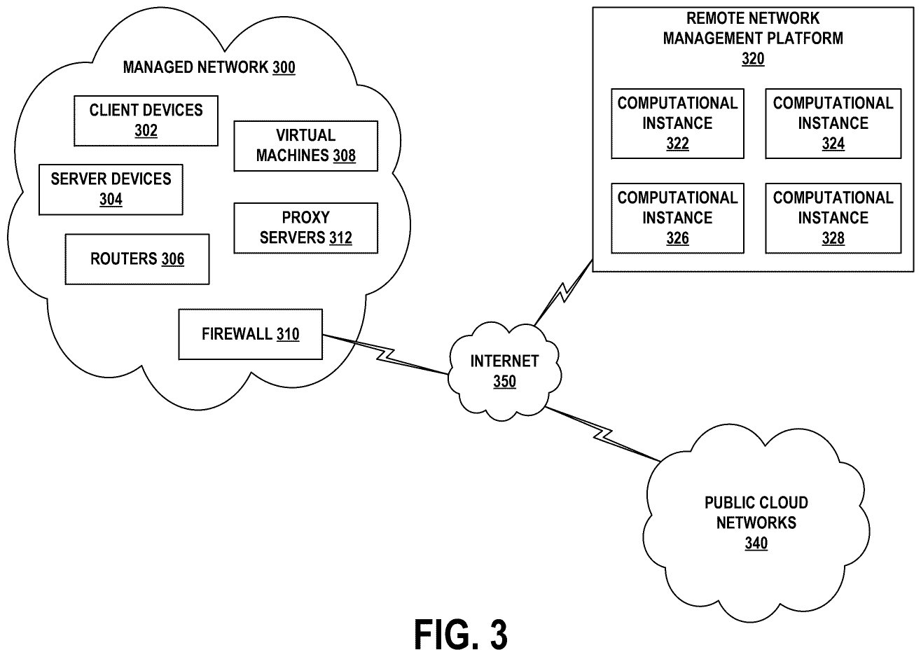

FIG. 3 depicts a remote network management architecture, in accordance with example embodiments. This architecture includes three main components managed network 300, remote network management platform 320, and public cloud networks 340-all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

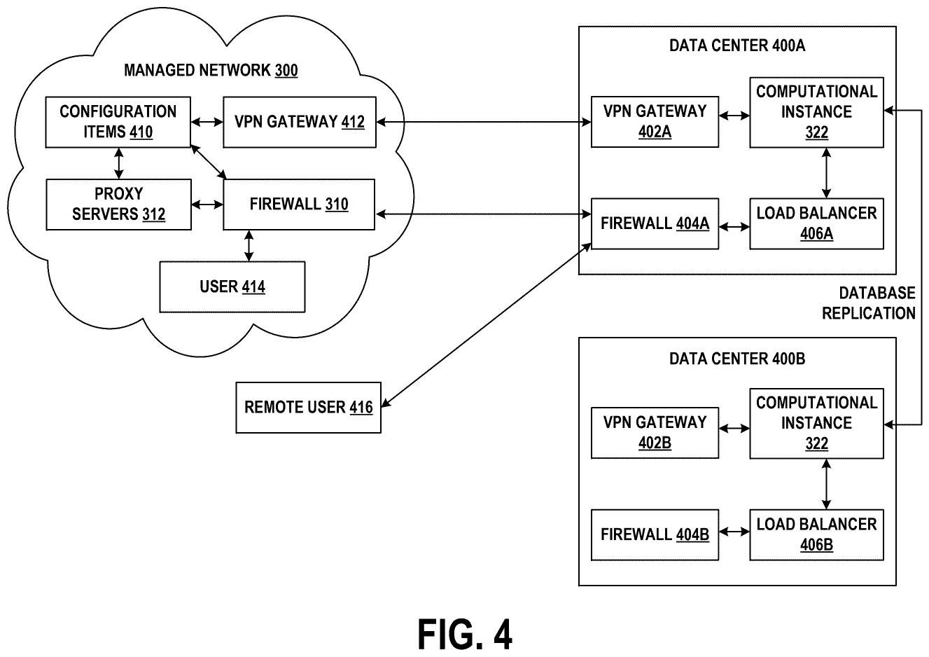

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

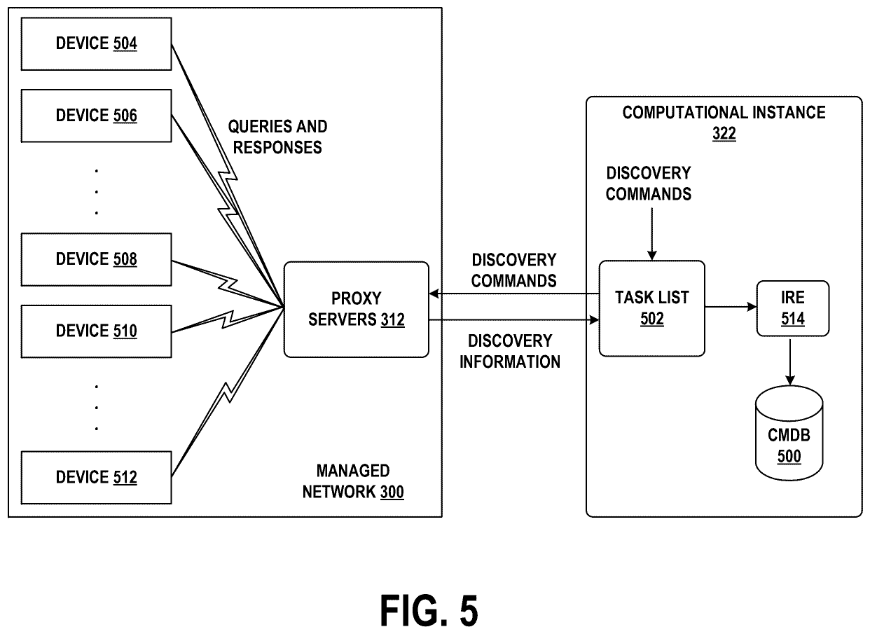

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®), a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices-for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Natural Language Models

Natural language models are machine learning systems trained to understand, generate, and/or predict human language by learning patterns from large datasets of text and possibly other sources. These models can perform tasks like translation, summarization, question answering, and/or conversation. A large language model (LLM) is an advanced natural language model, configured to understand, interpret, generate, and respond to human language in a manner that is both contextually relevant and syntactically coherent, allowing even colloquial conversation between a human user and the model.

The underlying structure of an LLM is typically based on a neural network architecture, more specifically, a variant of the transformer model. Transformers are notable for their ability to process sequential data, such as text, with high efficiency. LLM operation involves passing data through layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio Some LLMs can employ a form of reasoning by transforming user-provided natural language input into a structured internal representation, which is then used to generate a response based on learned statistical associations and contextual dependencies. For complex queries requiring multi-step inference (e.g., mathematical problems, logical deductions, or temporal event analysis), the LLM can decompose the problem into intermediate steps by generating latent representations that reflect intermediate reasoning states. These states are influenced by the training data and are shaped during inference through techniques such as masked self-attention, positional encoding, and next-token prediction, which collectively allow the LLM to simulate deductive or abductive reasoning processes. In some embodiments, explicit chain-of-thought prompting is used to guide the LLM in generating a sequence of intermediate natural language steps, enhancing the LLM's ability to produce structured reasoning outputs. This capability enables the LLM to generate responses that are not merely retrieved facts but the result of multi-step inferential synthesis over the input data and the LLM's internal knowledge representation.

### VIII. Multi-System Data Object Integration

Modern computing environments frequently depend on structured data originating from or associated with a multitude of applications, where each may employ distinct formats and organizational schemas. While this heterogeneity can offer certain benefits, it also introduces substantial challenges. Notably, the integration of such disparate data into workflows or artificial intelligence (AI)-enhanced functionalities remains a complex endeavor. Inadequate or incomplete data integration can lead to inefficiencies, compelling users to repetitively carry out certain tasks. This redundancy consumes additional computational resources-including processing, memory, network, and power capacity- and thus diminishes overall system performance. Furthermore, the fragmented nature of data storage and management across diverse applications can impede the effectiveness of security protocols, rendering systems more susceptible to vulnerabilities such as misconfigurations, malware, or unauthorized access. Consequently, there is an elevated risk of sensitive data exfiltration and potential service disruptions. Thus, there are technical advantages to having more unified, consistent, and secure data integration methodologies.

As used herein, the terms “database schema” and “schema” refers to a formal, machine-readable description of the logical organization of data within a database, comprising a set of defined entities (e.g., defined in tables or classes), each entity's attributes (e.g., columns or fields) with associated data types and constraints (e.g., primary keys, foreign keys, uniqueness, nullability), the relationships and referential integrity rules linking entities, and any indexing or partitioning structures employed to improve data access and/or reduce storage. A schema may further specify any inheritance or hierarchical structures, validation rules, and access control policies.

In some cases, an entity may be represented by more than one table-e.g., a “person” entity may have its attributes divided between a one table that defines the person's contact information and another than defines the person's job role. Thus, the representation of entities in tables need not be one-to-one.

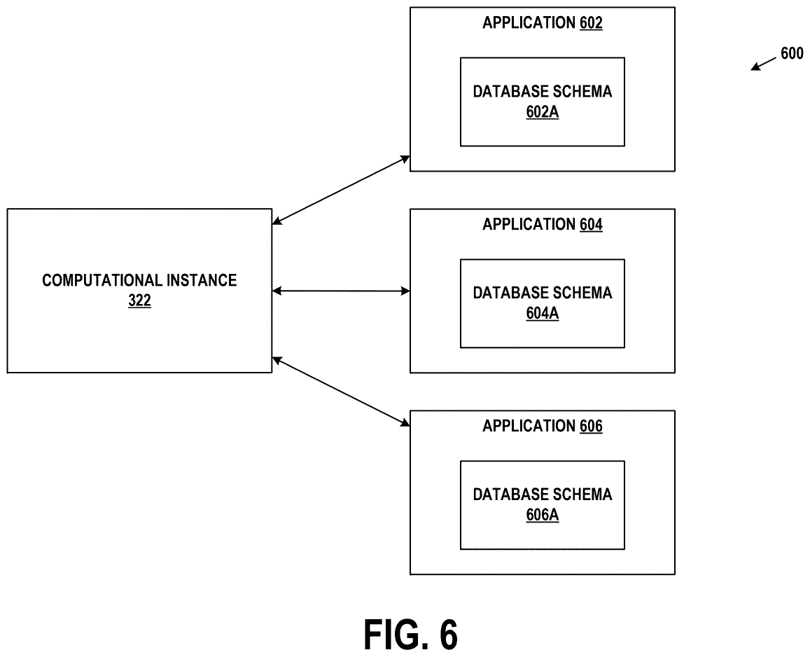

FIG. 6 depicts an example of such a multi-application environment 600. In FIG. 6, computational instance 322 interacts with applications employing databases having different schemas. Particularly, application 602 employs a database with schema 602A, application 604 employs a database with schema 604A, and application 606 employs a database with schema 606A. For sake of discussion, it is assumed that each of these schemas are different.

Integration of data from applications 602, 604, and 606, as well as their respective databases, can be challenging. Even an entity as simple as a U.S. zip code can be provided in multiple formats, such as with 5 digits (e.g., “12345”), with 9 digits separated by a hyphen (e.g., “12345-6789”), or with 9 digits stored as two different strings (e.g., “12345” and “6789”). In order to interact with data from each of applications 602, 604, and 606, computational instance 322 may be configured with its own representation—its own schema—to which these other schemas are mapped. For example, computational instance 322 may store zip codes as 9 digits without a hyphen (e.g., “123456789”) and mappings to and/or from this format and the formats of applications 602, 604, and 606 may be developed.

Such mappings, however, are not always straightforward. In some cases, information is lost (e.g., truncated) when mapping from one format to another. In other cases a mapping might not be apparent when schema columns use different names, but contains the same information.

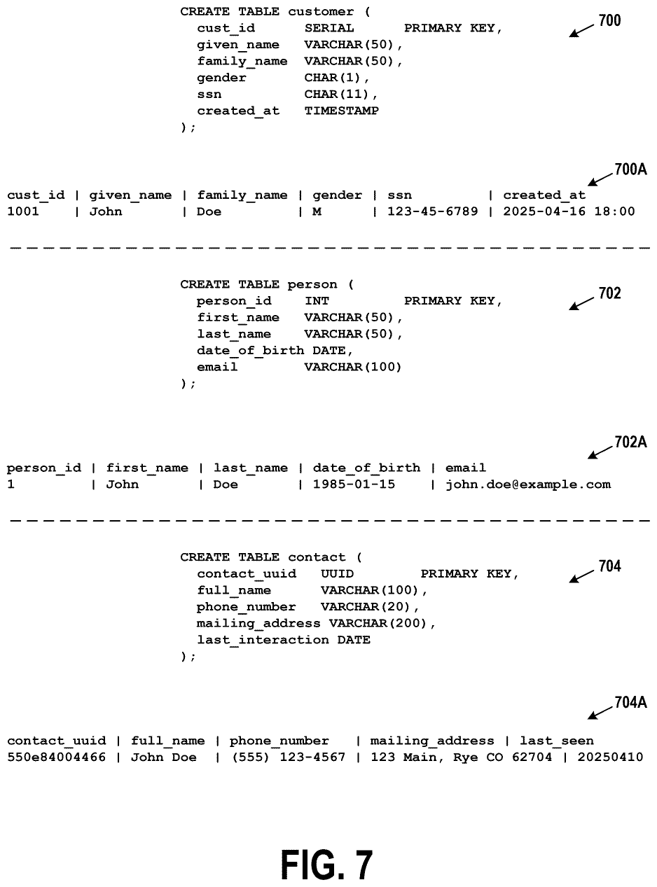

FIG. 7 provides a more involved example of mapping challenges, though one that is still relatively simple when compared to real-world deployments. In FIG. 7, there are three schemas, 700, 702, and 704, each defining a format for storing data related to an individual. An example entry 700A, 702A, and 704A is respectively provided for each schema.

In schema 700, customer data is stored in a table denoted customer. The customer table includes a primary key column cust_id (serial/integer), and columns given_name (varchar), family_name (varchar), gender (char), ssn (char), and created_at (timestamp). For instance, an example entry 700A may be populated as: cust_id=“1001”, given_name=“John”, family_name=“Doe”, gender=“M”, ssn=“123-45-6789”, and created at=“2025-04-16 18:00:00”.

In schema 702, human resources data is stored in a table denoted person. The person table includes a primary key column person_id (integer), and columns first_name (varchar), last_name (varchar), date_of_birth (date), and email (varchar). For instance, an example entry 702A may be populated as: person_id=“1,” first_name=“John”, last_name=“Doe”, date_of_birth=“1985-01-15”, and email=“john.doe@example.com”.

In schema 704, contact data is stored in a table denoted contact. The contact table includes a primary key column contact_uuid (UUID), and columns full name (varchar), phone_number (varchar), mailing_address (varchar), and last_interaction (date). For instance, example entry 704A may be populated as: contact_uuid=“550e84004466”, full_name =“John Doe”, phone_number=“(555) 123-4567”, mailing_address=“123 Main St, Springfield, IL 62704”, and last_interaction=“2025-04-10”.

Each of the three schemas captures overlapping but distinct subsets of a person's data, and each omits some fields present in the others. The customer table of schema 700 holds a unique integer identifier (cust_id), separate given and family name fields, gender, social security number, and a timestamp for record creation; it therefore provides identity verification and audit information but lacks date of birth, contact channels (email, phone, mailing address), and interaction history. The person table of schema 702 likewise supplies a unique integer ID (person_id), first and last names, date of birth, and an email address—useful for demographic profiling and electronic communication—but omits gender, SSN, record-creation timestamps, telephone number, postal address, and last interaction date. The contact table of schema 704 uses a UUID key (contact_uuid) and a full_name field, and records phone number, mailing address, and the date of last interaction—supporting outreach and engagement tracking—but does not store separate given/family names, date of birth, email address, gender, SSN, or creation timestamp.

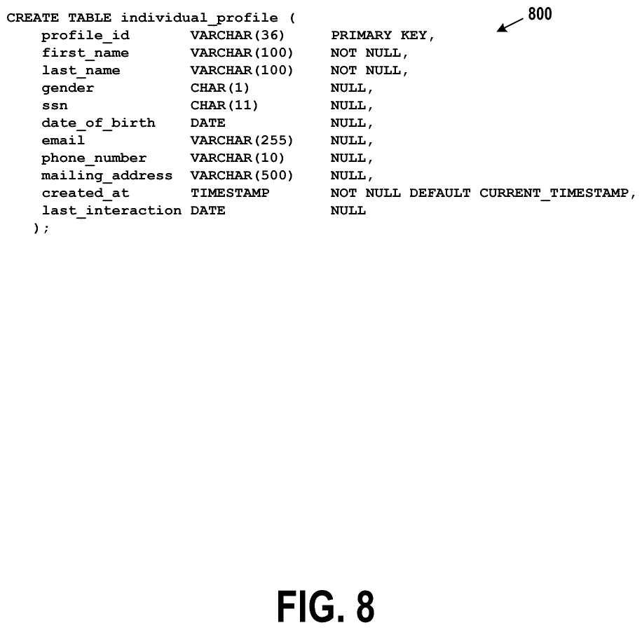

FIG. 8 depicts one possible option for unifying these three different schemas so that their data can be stored in computational instance 322. In FIG. 8, integrated schema 800 includes a single table, referred to as individual_profile. This table defines a primary key field profile_id of type VARCHAR(36), configured to store either a text-encoded UUID or a legacy integer identifier. Personal identifiers are maintained in non-nullable first name and last_name fields (each VARCHAR(100)), and a gender field (CHAR(1)) stores a single-character code. A ssn field (CHAR(11)) holds a U.S. social security number in the format “123-45-6789,” and a date_of_birth field (DATE) records the individual's birth date. Contact channels are represented by email (VARCHAR(255)), phone_number (VARCHAR(20)), and mailing_address (VARCHAR(500)). Temporal metadata includes a created_at timestamp (defaulting to the insertion time) and a last_interaction date indicating the most recent engagement.

In other possible options, integrated schema 800 may be altered in various ways based on design preferences or to suit particular application requirements. For example, the profile_id field may be implemented as a native UUID type, an integer, or a composite key combining multiple columns. Additional fields-such as middle names, preferred language, or multi-factor authentication tokens-may be added or omitted. Likewise, the ordering, data types, lengths, and nullability constraints of existing columns (e.g., email, phone_number, mailing_address) may be modified, and alternative indexing or partitioning schemes may be applied to improve performance. In some embodiments, the individual_profile table may be split into separate but linked subtables (e.g., profile_identity, profile_contact) with foreign-key relationships, thereby enabling modular data storage. Other variations include using encrypted or hashed representations of sensitive fields (such as SSNs) or incorporating audit-trail columns (such as last-updated-by and update timestamps). Each of these alternatives provides a respective trade-off among storage efficiency, query performance, security, and extensibility. Other possible variations of integrated schema 800 exist. Moreover, since there is no one correct way to integrate disparate schemas into a common format, various approaches rely on subjective decisions and experiences of database engineers.

Mapping data from each of the databases using schemas 602A, 604A, and 606A into integrated schema 800 presents several challenges. First, differences in identifier formats—serial integers in customer cust_id and person.person_id versus UUIDs in contact.contact_uuid-may require normalization into the single profile_id field, which may involve casting or text—encoding of numeric IDs. Second, divergent name representations (separate given_name/family_name versus first_name/last_name versus concatenated full_name) may necessitate parsing or concatenation logic to populate first_name and last name consistently. Third, the timestamp of schema 700 (created_at) and date of schema 704 (last_interaction) use different temporal granularities and formats, requiring conversion routines to standardize these fields. Fourth, some attributes are exclusive to one source—e.g., SSN and gender from the customer table, date of birth and email from the person table, and phone/address from the contact table—so mappings may have to accommodate nulls where data are absent and enforce appropriate constraints only when the source provides values. Fifth, data-quality issues such as inconsistent formatting (e.g., hyphens in SSNs or phone numbers), incomplete records, or conflicting entries (e.g., different birth dates for the same individual) should be resolved through validation, cleaning, and reconciliation processes before or during the migration.

So far, this discussion has focused on the challenges of mapping data from different schemas into an integrated schema. But when schemas 700, 702, and 704 contain multiple interrelated tables, designing an integrated schema raises additional complications beyond just column mapping. Tables that form coherent subsystems—such as an orders table linked to customer and product tables in one schema, or an employment-history table linked to person and department tables in another—may need to have their foreign-key relationships remapped to the consolidated primary-key space (e.g., the unified profile_id), which entails updating child-table constraints as well as join view, and referential-integrity rules. Varying cardinalities across schemas (one-to-many in one domain, many-to-many in another) may require introducing bridging entities or junction tables to represent associations correctly without losing information.

### IX. Entity Representation, Mapping, and Resolution

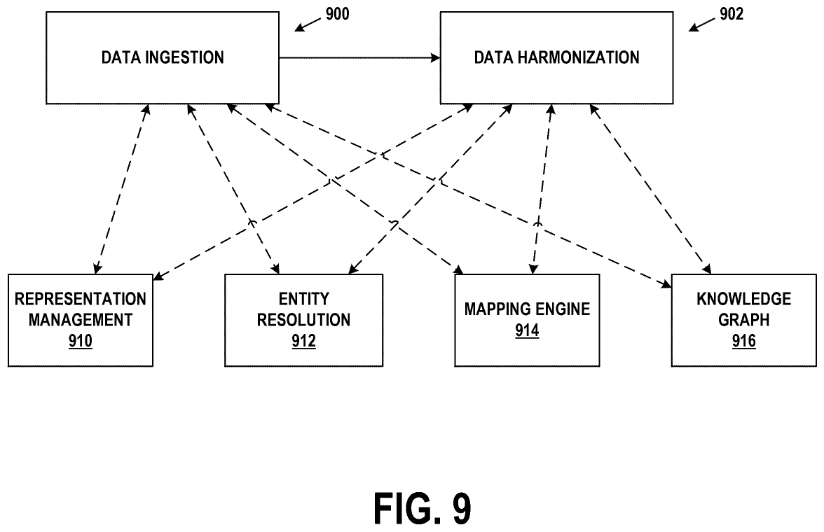

FIG. 9 depicts an overview of a process for data ingestion and harmonization. Data ingestion 900 relates to data extraction, transformation, and loading (ETL) from multiple source platforms (e.g., applications 602, 604, and 606) into a unified platform (e.g., computational instance 322). The challenges that can be addressed include variability in APIs, protocols, and formats used by different source platforms and applications. Data harmonization 902 relates to creation of a unified semantic representation that integrates the schemas of the source databases (e.g., those with schemas 602A, 604A, and 606A, respectively). The challenges that can be addressed include inconsistent terminologies, field names, value encodings, and relationships in different source platform databases.

As denoted in FIG. 9 by way of dashed lines, each of data ingestion 900 and data harmonization 902 may rely on and/or interact with various software modules, such as representation management 910, entity resolution 912, mapping engine 914, and/or knowledge graph 916. Representation management 910 may involve developing a structured representation of data entities (e.g., database tables), their properties (e.g., fields), and the relationships therebetween (e.g., references from a field in one table to an entry in another). Entity resolution 912 may involve identifying and merging entries that refer to the same real-world entity across different source schemas. Mapping engine 914 may involve processing data from entries that refer to the same real-world entity across different systems to populate a database in accordance with the integrated schema. Knowledge graph 916 may involve creating a knowledge graph from the integrated schema and its data (e.g., enhanced with AI-driven embeddings to improve searchability). Nonetheless, some of these software modules may be omitted or may be used in various orderings.

The subsections below further illustrate the possible operations carried out for each of these blocks. This description is not intended to be exclusive and other operations are possible.

### A. Representation Management

Representation management 910 may involve constructing an ontogeny management system for supporting the structured representation of various entities and relationships therebetween. Doing so may involve a number of steps, examples of which follow.

A primary schema may be chosen as the foundational representation. For example, this may be any one of schemas 602A, 604A, or 606A, for example. The primary schema may be chosen based on various criteria, such as the number of tables in the schema, the number of fields in the tables, and/or how well the schema can be generalized to support the data stored across schemas 602A, 604A, or 606A. In some embodiments, schemas 602A, 604A, and 606A may be provided to a natural language model (e.g., an LLM) with a prompt instructing it to select the one that generalizes best.

With the primary schema selected, any metadata associated with its tables, such as entity names (e.g., table names), field names, field properties, and/or relationships with other tables may be extracted and stored in conjunction with the primary schema. For certain applications, key entities may be identified. For instance, in an incident management application, key entities may include an incidents table, a users table, and a technician table, where a user stored in the users table can open an incident that is stored in incidents table, and where the incident is assigned to a technician from the technicians table for resolution. Key entities are selected so that the accuracy of information that is likely to be most important to the application can be given special attention (if needed). The accuracy of information relating to other entities represented in the primary schema may be less important and given less emphasis.

Then, tables, fields, and relationships may be extracted from the other schemas. The primary schema may be generalized based on this information. As an example, suppose that schema 700 is selected as the primary schema. It may be generalized into integrated schema 800 by incorporating fields from schemas 702 and 704 into schema 700. The manner of this generalization (e.g., the information chosen from the non-primary schemas to be added to the primary schema and the names of any new fields added to the primary schema) may include doing so by way of LLM prompting. Once generalized, the primary schema may be referred to as the integrated schema.

### B. Entity Resolution

Entity resolution 912 may involve identifying and merging representations of entities (e.g., objects) across different systems, where these representations relate to or are the same real-world entity. This facilitates reduction in redundancy and duplication of data, while increasing data accuracy. Regardless, entity resolution 912 may include one or more of the following steps: data preprocessing, blocking strategy, attribute similarity calculation, rule-based matching, machine-learning-based matching, clustering of similar entries, and merging and resolving entities. These steps may be performed in the order given above or in a different order.

### 1. Data Preprocessing

Data preprocessing may involve normalizing the values of database table entries. This could include standardizing date formats, address formats, and capitalization, as well as removing extraneous spaces, punctuation, and special characters from these values. For example, a U.S. phone number could be represented in various source schemas according to the following formats: “123-456-7890”, “(123) 456-7890”, and “(123) 456 7890”. Integrated schema 800 may employ yet a different format with extraneous spaces, punctuation, and special characters removed, such as “1234567890”.

### 2. Blocking Strategy

Blocking strategy may involve grouping similar entries based on key attributes to reduce computational complexity. An example of this would be to group entries representing an individual by phone number or email before performing detailed comparisons. Since phone numbers and email addresses tend to refer to a unique individual, doing so reduces the number of overall entries that need to be considered.

### 3. Attribute Similarity Calculation

Attribute similarity calculation may involve further grouping of entries based on their having corresponding fields with similar (but not necessarily identical) values. For example, the name of an individual can be expressed differently and/or misspelled. An individual with the name “John Smith” could have their name stored in different databases as “John Smith”, “Jon Smith”, and “Jonathan Smith”. When entries from source schemas 700, 702, and 704 are placed in integrated schema 800, it may be desirable to avoid duplicate entries for the same person due to different spellings of their name. Such duplicate entries waste memory and processing resources associated with their storage and retrieval.

Accordingly, several techniques can be employed in order to reduce the likelihood of such duplicate entries. One may involve considering values of other fields that are often unique for an individual, such as their phone number and/or email address. If entries of two different database tables have different spellings of the individual's name but these entries have a common phone number and email address for the individual, then it is almost certain that the two entries actually refer to the same individual and only one corresponding entry needs to be made in integrated schema 800.

Alternatively or additionally, machine learning and AI techniques can be used to identify entries that may refer to the same individual. For example, name-entity resolution techniques may combine string similarity measures, phonetic encoding, learned embeddings, and contextual features to detect when two differently spelled or misspelled names actually refer to the same individual. Such algorithms may compute edit-distance (e.g. Levenshtein distance) between name tokens (e.g., “Jon” versus “John” has a distance of one). Phonetic encodings, such as Double Metaphone, can translate names into sound-based codes, causing variants that sound alike (e.g. “Jon” and “John”) to match even when letter patterns differ. More advanced systems embed full names into high-dimensional vectors-using transformer models or name-specific neural network encoders- and then cluster or compare them by cosine similarity, capturing subtler variations such as “Aleksandr” versus “Alexander”.

Another similarity technique may be based on term frequency-inverse document frequency (TF-IDF). This may involve projecting n-grams of names into a vector space and determining the similarities thereof using cosine similarity or other similarity metrics.

Also, supervised “same-entity” classifiers can learn directly from labeled pairs of matching and non-matching names, integrating both string and phonetic features. To reduce false positives, these string-based signals are often augmented with contextual data (date of birth, email domain, or address), so that a high name-similarity score combined with matching auxiliary fields yields strong evidence of a single individual.

Any of these techniques may be used for other types of fields. Such fields could include mailing addresses (“123 Main Street Apt #4” versus “123 Main St Apt. 4”), company names (e.g., “Company” versus “Company, Inc.”), geographic regions (e.g., “United States” versus “USA”), dates and times (e.g., “01/02/2025” versus “1 Feb. 2025”), and so on.

For other types of data, different techniques could be used. For example, Jaccard similarity may be employed when the data takes the form of sets.

### 4. Rule-Based Matching

Rule-based matching may involve defining and using deterministic rules for matching entries. For example, one possible rule is that when the name and phone number of two different entries match exactly, they should be considered to be the same entity and possibly consolidated into a common entry. On the other hand, if the email address of two different entities matches but the mailing address only matches partially, these entries can be flagged as potentially matching. Potentially matching entries can be manually reviewed by an administrator and marked as either an actual match or not a match.

### 5. Machine-Learning-Based Matching

Machine-learning-based matching may involve training models using labeled datasets to classify entries as matches or non-matches. This may involve using exact matches (e.g., phone number, email address), fuzzy matches (e.g., similarity-based metrics for names, addresses), and/or probabilistic scoring models (e.g., Bayesian classifiers, decision trees). Here, the fuzzy matches may different from those discussed above, and may instead be based on word vectors, paragraph vectors, transformer-based models, and so on.

### 6. Clustering of Similar Entries

Clustering of similar entries may also be used to group entries that are duplicates or possible duplicates. Various clustering techniques may be used, such as k-means or density-based spatial clustering of applications with noise (DBSCAN). K-means is a partitioning algorithm that assigns each entry to one of k clusters by iteratively relocating cluster centroids to the mean of their assigned entries (e.g., as determined by projection into vector space of one or more values of fields within the entries) and reassigning entries to the nearest centroid. DBSCAN groups entries into clusters based on local entry density (e.g., from projecting entries into a vector space). DBSCAN may mark entries in low-density regions as noise without requiring a preset number of clusters.

Once the entries are clustered in some fashion, confidence indicators (e.g., scores) may be assigned to the clusters to represent how likely the entries therein are duplicates of one another. As an example, for each cluster, the average (or minimum) pairwise similarity across as set of key fields may be determined, possibly with each field given a different weight. The result is normalized to a 0.0-1.0 range. A high confidence indicator (e.g. >0.9) specifies that the entries in the cluster likely represent the same individual, whereas a low confidence indicator suggests ambiguity and that human review may be required.

Notably, confidence indicators may be used when determining whether any two or more entries from different source tables should be merged. As a more detailed example, each pair of records can be compared field by field using a normalized similarity function. This could be an edit distance for names (yielding a value between 0.0 for completely different strings and 1.0 for exact matches), a numeric distance score for dates or numbers (e.g. 1.0 minus the scaled absolute difference), and a binary exact match indicator for identifiers like phone number or email address. Given the per-field similarities, each field can be assigned a weight proportional to its discriminative power (for instance, date of birth might carry more weight than gender). Then, the overall confidence indicators can be calculated as the weighted average of all field scores. Because each field score and all weights lie between 0 and 1 and weights sum to 1, the resulting value naturally falls in the 0.0-1.0 interval.

### 7. Merging and Resolving Entities

When two (or more) entries are to be merged, the values of their respective fields may be combined into a single entry. Conflict resolution rules may be applied to decide which values to retain. For example, if two entries to be merged have different phone numbers, the most recently updated entry may be used in the merged entry.

### C. Mapping Engine

In the embodiments herein, mapping engine 914 may include one or more units of software that facilitates the development and maintenance of mappings between the integrated schema (e.g., schema 800) and each of the source schemas (e.g., schemas 602A, 604A, and 606A). Here, it may be assumed that corresponding entities (e.g., tables or sets of tables) have been identified between the integrated schema and each of the source schemas. The mappings are between fields and field values of these entities.

Determining such mappings may involve, among other possible activities, (i) identifying, possibly based on the metadata, corresponding fields between the integrated schema and each of the source schemas, (ii) using reverse lookups of the values stored in entries of these schemas in order to determine the formats of corresponding values in corresponding fields of other schemas, and (iii) developing mapping rules and logic for how these values can be transformed between the representations of the integrated schema and each of the source schemas. However, such steps may be ordered or arranged differently.

Throughout, machine learning and/or generative AI may be used to facilitate any of these activities. Further, these activities may take place in various orderings, including but limited to the ordering given above. In some cases, the operations of mapping engine 914 relies on or otherwise uses the attribute similarity, rule-based mapping, machine-learning-based matching, clustering, and/or other techniques discussed above in the context of entity resolution.

As an example of mappings, the fields in schemas 700, 702, and 704 that include the string “name” all refer to at least part of an individual's name. Thus, those respective fields from each of schemas 700, 702, and 704 may be considered to be corresponding fields that should each be mapped to common fields in integrated schema 800 (i.e., “first_name” and “last_name”). These corresponding fields may be identified by the common string in their field names.

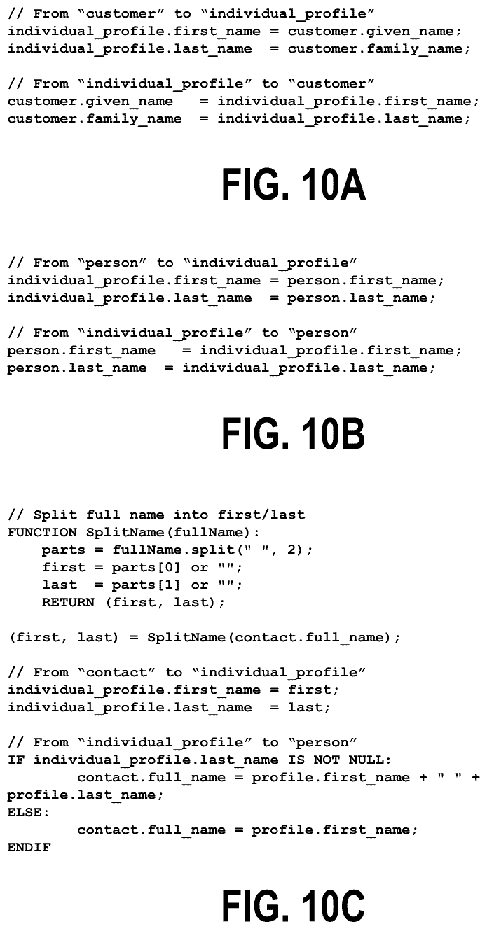

FIG. 10A depicts pseudocode for such mappings between schema 700 and integrated schema 800. Likewise, FIG. 10B depicts pseudocode for similar mappings between schema 702 and integrated schema 800. These are examples of one-to-one relationships between corresponding units of data.

FIG. 10C depicts pseudocode for similar mappings between schema 704 and integrated schema 800. Since schema 704 uses one field for names and integrated schema 800 uses two fields for names, mapping logic is included in FIG. 10C that can facilitate mappings in both directions. This is because there is one-to-many relationship between the corresponding units of data when mapping from schema 800 to schema 704 and a many-to-one relationship between the corresponding units of data when mapping from schema 704 to schema 800).

Regardless, any such pseudocode may be executed for each entry (row) in the corresponding tables as needed in order to ingest data stored in accordance with any of schemas 700, 702 and/or 704 into integrated schema 800 or in order to push data stored in accordance with integrated schema 800 into any of schemas 700, 702 and/or 704. Thus, more sophisticated mapping logic may be needed when the same information being represented as one field in a first schema is represented as multiple fields in a second schema. Also, special mapping logic may be required when different representations of the same data are possible.

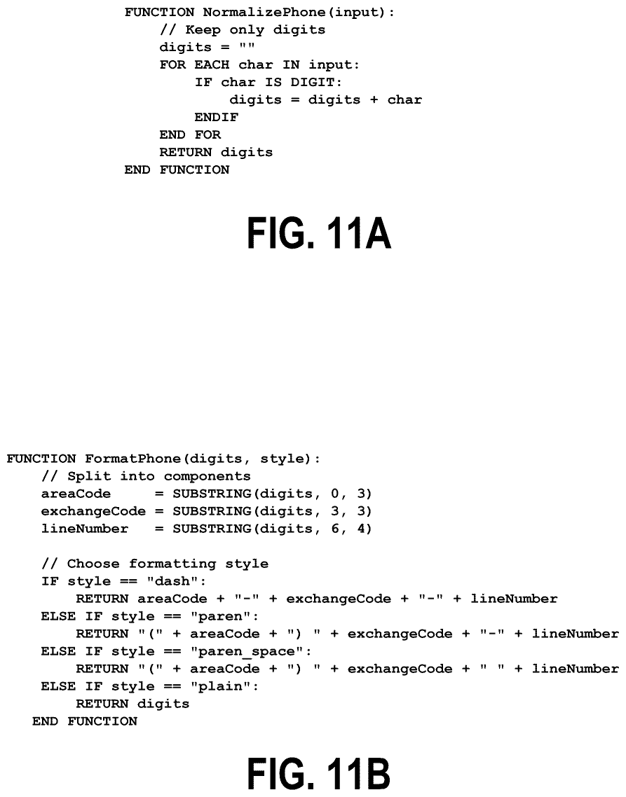

As an example, FIG. 11A depicts example pseudocode for transforming phone numbers from the “123-456-7890”, “(123) 456-7890”, and “(123) 456 7890” formats into the “1234567890”. FIG. 11B depicts pseudocode for transforming phone numbers from the “1234567890” format into any of the “123-456-7890”, “(123) 456-7890”, and “(123) 456 7890” formats.

Any combination of mapping logic involving transforming entries between different numbers of fields, different formats of fields, and applying machine learning and/or AI techniques may be used. In some cases, generative AI may be employed to suggest or determine which of these techniques to use for each field or a set of fields.

Once these mapping rules and logic are determined for each pair of schemas, they may be encoded and stored in various ways (e.g., as executable code, in a JSON or XML file, or in a relational database. The mappings may be periodically updated, validated, and tested to ensure that mapped fields yield the expected results. Thus, mapping engine 914 may develop such mapping rules and logic in various ways, and then use these rules when moving data in and out of integrated schema 800.

### D. Knowledge Graph Creation

Once an integrated schema has been developed, it may be transformed into a knowledge graph representation. In such a knowledge graph, nodes represent entities (e.g., from one or more tables) and edges between nodes represent connections or relationships between entities. Unlike traditional relational schemas, a knowledge graph can flexibly ingest data from multiple sources—each with its own structure—by mapping source fields onto a shared ontology and creating unified, typed relationships. Knowledge graphs also have the advantage of being easily queried by machine learning and AI models.

Construction of a knowledge graph may involve one or more of the following steps. These steps may be performed in the order given or in a different ordering.
Step 1: defining knowledge graph nodes using the entities determined by the entity resolution techniques described above. Relationships in the knowledge graph may be based on the attribute similarity calculations described above. The knowledge graph may be stored in a graph database form, such as that of Neo4j (an efficient storage technique for graph data that facilitates fast lookups) or resource description framework (RDF) graphs.
Step 2: ingesting data from source schema of various software applications. This may involve transforming database tables into graph structures using ETL processes.
Step 3: creating and populating nodes and edges. This may involve converting entities into graph nodes with their associated attributes, and linking nodes using edges based on relationships.
Step 4: implement querying mechanisms. This may involve using techniques such as Cypher (for Neo4j) or SPARQL (for RDF graphs) to retrieve insights from the knowledge graph.
Step 5: enhancement with machine learning and AI. This may involve using embeddings (e.g., vector embeddings) to improve searchability and/or implementing natural language processing for semantic search.
Step 6. Integrating with other applications. This may involve exposing the knowledge graph APIs for use by other applications operating on or in conjunction with computational instance 322. Examples include analytics dashboards and chatbots.

### X. Example Architecture

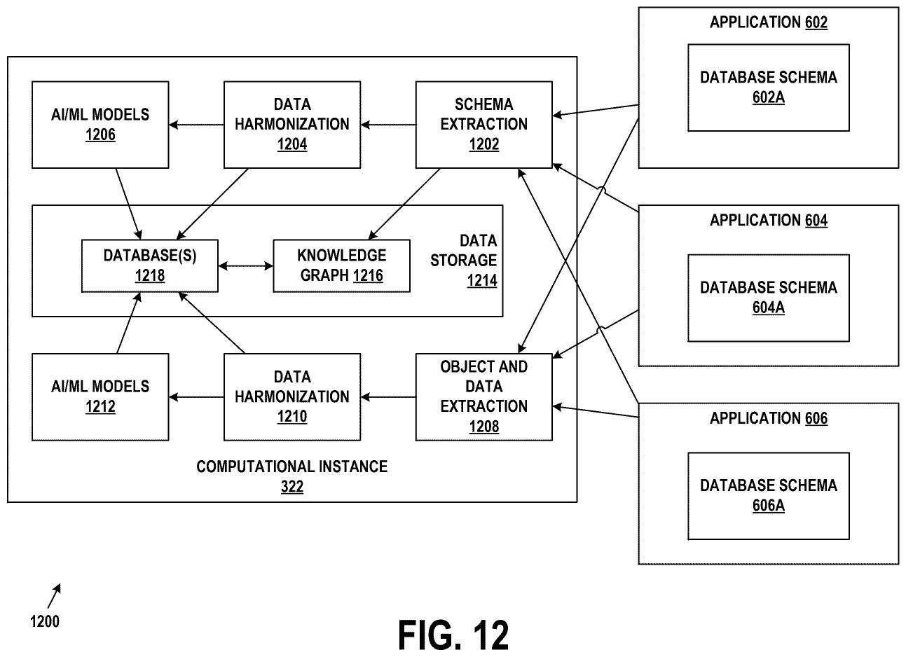

FIG. 12 depicts an architecture 1200 for employing the data structures, procedures, and techniques for entity representation discussed herein. Architecture 1200 expands upon the arrangement of systems depicted in FIG. 6, and provides more detail with regard to the operations of computational instance 322.

Particularly, schema extraction 1202 may involve computational instance 322 querying various APIs of applications 602, 604, and 606 to obtain their respective schemas 602A, 604A, and 606A. Representation management and entity resolution techniques may be used to derive an integrated schema from schemas 602A, 604A, and 606A and to develop knowledge graph 1216. Data harmonization 1204 involves creating mapping rules and logic to transform field names and values from schemas 602A, 604A, and 606A into the integrated schema. Data harmonization 1204 may employ artificial intelligence/machine learning (AI/ML) models 1206 to facilitate these processes. The integrated schema is stored in database(s) 1218.

Object and data extraction 1208 obtains copies of the data within the databases of applications 602, 604, and 606 (where these databases are arranged in accordance with schemas 602A, 604A, and 606A, respectively). Data harmonization 1210 involves using mapping rules and logic to transform field names and values from schemas 602A, 604A, and 606A into the integrated schema. Data harmonization 1210 may employ AI/ML models 1212 to facilitate these processes. The integrated data is stored in database(s) 1218 in accordance with the integrated schema.

After database(s) 1218 are populated, they may be queried by various applications operating on or in conjunction with computational instance 322. For example, workflow-based applications, such as incident management or security vulnerability detection applications may query knowledge graph 1216 and/or database(s) 1218 in order to take the integrated data stored in database(s) 1218 into account.

### XI. Example Operations

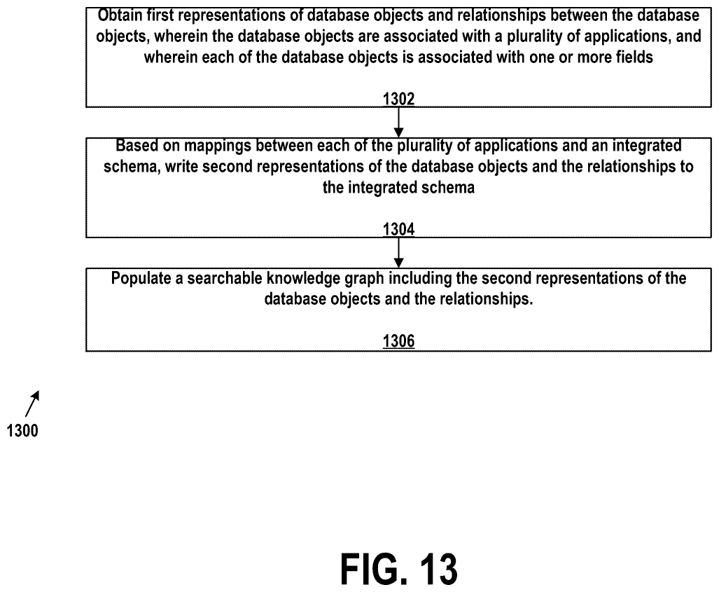

FIG. 13 is a flow chart 1300 illustrating an example embodiment. The process illustrated by FIG. 13 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 13 may be simplified by the removal of any one or more of the features shown therein. Further, these embodiments may be combined with features, aspects, and/or implementations of any of the previous figures or otherwise described herein.

Block 1302 may involve obtaining first representations of database objects and relationships between the database objects, wherein the database objects are associated with a plurality of applications, and wherein each of the database objects is associated with one or more fields.

Block 1304 may involve, based on mappings between each of the plurality of applications and an integrated schema, writing second representations of the database objects and the relationships to the integrated schema.

Block 1306 may involve populating a searchable knowledge graph including the second representations of the database objects and the relationships.

These features involves technical improvements to database and computing systems. First, by mapping equivalent database objects and fields from multiple databases into a single knowledge graph representation, redundant entries and fields can be eliminated, thereby shrinking the overall data footprint and the in-memory structures needed to hold it during query execution. Second, knowledge graphs can employ native storage formats (e.g., adjacency lists) that compress relationship data more efficiently than relational database join tables, further reducing the disk and RAM required for datasets (especially, large, highly connected datasets).

Third, query execution and processor utilization also improve markedly when using a knowledge graph instead of multiple siloed relational database schemas. Typical multi-schema joins in relational databases may involve repeated index scans, sort-merge or hash-join operations, and materialization of intermediate results; each step consumes processor cycles, memory for temporary buffers, and I/O bandwidth. In contrast, knowledge graph traversal operations follow pointers (edges) directly between in-memory node structures, reducing both the number of processor instructions per lookup and the need to load large intermediate tables.

In some embodiments, writing the second representations of the database objects and the relationships to the integrated schema comprises: determining a confidence indicator for two or more of the database objects represented in the integrated schema, wherein the confidence indicator specifies a likelihood that the two or more of the database objects are duplicates of one another; determining that the confidence indicator exceeds a pre-determined value; and, in response to the confidence indicator exceeding the pre-determined value, merging, into a common database object, the two or more of the database objects, wherein the searchable knowledge graph includes the common database object in place of the two or more of the database objects.

In some embodiments, the two or more of the database objects have been clustered with each other based on a similarity metric applied to their respective one or more fields.

In some embodiments, the database objects comprise database tables used by the plurality of applications.

In some embodiments, the one or more fields are represented as attributes or columns of the database tables.

In some embodiments, the mappings and the second representations are stored within a computational instance operated by a first organizational entity, wherein the plurality of applications are disposed outside of the computational instance and operated by organizational entities other than the first organizational entity.

In some embodiments, the mappings include logic that transforms the first representations into the second representations.

In some embodiments, the logic includes deterministic rules that transform at least some of the first representations into at least some of the second representations.

In some embodiments, the logic includes non-deterministic, similarity-based rules that transform at least some of the first representations into at least some of the second representations.

Some embodiments may further involve searching the searchable knowledge graph based on a search request from a user or from an artificial intelligence model.

Some embodiments may further involve, prior to obtaining the first representations of the database objects and the relationships: ingesting schemas relating to the first representations; determining, from the schemas, the mappings and the searchable knowledge graph; and storing, in a memory, the mappings and the searchable knowledge graph.

In some embodiments, the mappings include removal of whitespace or punctuation from strings.

In some embodiments, the mappings include combining of multiple strings into one string or separation of one string into multiple strings.

In some embodiments, the searchable knowledge graph encodes at least some of the second representations as vector embeddings.

### XII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A method comprising:
obtaining, from two or more databases, first representations of database objects and relationships between the database objects, wherein the database objects are associated with a plurality of applications, and wherein each of the database objects is associated with one or more fields;
determining an integrated schema based on the first representations of the database objects, wherein the integrated schema comprises schema fields based on the one or more fields associated with the database objects;
determining a mapping between the integrated schema and the plurality of applications; based on the integrated schema and the mapping, writing second representations of the database objects and the relationships to an integrated database, wherein writing the second representations of the database objects to the integrated database comprises merging redundant database objects identified based on similarities between values appearing in corresponding fields of the redundant database objects; and
populating a searchable knowledge graph including the second representations of the database objects and the relationships.

2. The method of claim 1, wherein merging the redundant database objects identified based on the similarities between the values appearing in the corresponding fields of the redundant database objects comprises:
determining a confidence indicator for two or more of the database objects represented in the integrated schema, wherein the confidence indicator specifies a likelihood that the two or more of the database objects are redundant with one another;
determining that the confidence indicator exceeds a pre-determined value; and
in response to the confidence indicator exceeding the pre-determined value, merging, into a common database object, the two or more of the database objects, wherein the searchable knowledge graph includes the common database object in place of the two or more of the database objects.

3. The method of claim 2, wherein the two or more of the database objects have been clustered with each other based on a similarity metric applied to their respective one or more fields.

4. The method of claim 1, wherein the database objects comprise database tables used by the plurality of applications.

5. The method of claim 4, wherein the one or more fields are represented as attributes or columns of the database tables.

6. The method of claim 1, wherein the mapping and the second representations are stored within a computational instance operated by a first organizational entity, and wherein the plurality of applications are is disposed outside of the computational instance and operated by organizational entities other than the first organizational entity.

7. The method of claim 1, wherein the mapping includes logic that transforms the first representations into the second representations.

8. The method of claim 7, wherein the logic includes deterministic rules that transform at least some of the first representations into at least some of the second representations.

9. The method of claim 7, wherein the logic includes non-deterministic, similarity-based rules that transform at least some of the first representations into at least some of the second representations.

10. The method of claim 1, further comprising:
searching the searchable knowledge graph based on a search request from a user or from an artificial intelligence model.

11. The method of claim 1, further comprising prior to obtaining the first representations of the database objects and the relationships:
ingesting schemas relating to the first representations;
determining, from the schemas, the mapping and the searchable knowledge graph; and
storing, in a memory, the mapping and the searchable knowledge graph.

12. The method of claim 1, wherein the mapping includes removal of whitespace or punctuation from strings.

13. The method of claim 1, wherein the mapping includes combining of multiple strings into one string or separation of one string into multiple strings.

14. The method of claim 1, wherein the searchable knowledge graph encodes at least some of the second representations as vector embeddings.

15. A non-transitory computer-readable medium, having stored thereon program instructions that, upon execution by a computing system, cause the computing system to perform operations comprising:
obtaining, from two or more databases, first representations of database objects and relationships between the database objects, wherein the database objects are associated with a plurality of applications, and wherein each of the database objects is associated with one or more fields;
determining an integrated schema based on the first representations of the database objects, wherein the integrated schema comprises schema fields based on the one or more fields associated with the database objects;
determining a mapping between the integrated schema and the plurality of applications; based on the integrated schema and the mapping, writing second representations of the database objects and the relationships to an integrated database, wherein writing the second representations of the database objects to the integrated database comprises merging redundant database objects identified based on similarities between values appearing in corresponding fields of the redundant database objects; and
populating a searchable knowledge graph including the second representations of the database objects and the relationships.

16. The non-transitory computer-readable medium of claim 15, wherein merging the redundant database objects identified based on the similarities between the values appearing in the corresponding fields of the redundant database objects comprises:
determining a confidence indicator for two or more of the database objects represented in the integrated schema, wherein the confidence indicator specifies a likelihood that the two or more of the database objects are redundant with one another;
determining that the confidence indicator exceeds a pre-determined value; and
in response to the confidence indicator exceeding the pre-determined value, merging, into a common database object, the two or more of the database objects, wherein the searchable knowledge graph includes the common database object in place of the two or more of the database objects.

17. The non-transitory computer-readable medium of claim 15, wherein the mapping includes logic that transforms the first representations into the second representations, and wherein the logic includes deterministic rules that transform at least some of the first representations into at least some of the second representations.

18. The non-transitory computer-readable medium of claim 15, wherein the mapping includes logic that transforms the first representations into the second representations, and wherein the logic includes non-deterministic, similarity-based rules that transform at least some of the first representations into at least some of the second representations.

19. The non-transitory computer-readable medium of claim 15, the operations further comprising, prior to obtaining the first representations of the database objects and the relationships:
ingesting schemas relating to the first representations;
determining, from the schemas, the mapping and the searchable knowledge graph; and
storing, in a memory, the mapping and the searchable knowledge graph.

20. A system comprising:
one or more processors; and
memory, containing program instructions that, upon execution by the one or more processors, cause the system to perform operations comprising:
obtaining, from two or more databases, first representations of database objects and relationships between the database objects, wherein the database objects are associated with a plurality of applications, and wherein each of the database objects is associated with one or more fields;
determining an integrated schema based on the first representations of the database objects, wherein the integrated schema comprises schema fields based on the one or more fields associated with the database objects;
determining a mapping between the integrated schema and the plurality of applications;
based on the integrated schema and the mapping, writing second representations of the database objects and the relationships to an integrated database, wherein writing the second representations of database objects to the integrated database comprises merging redundant database objects identified based on similarities between values appearing in corresponding fields of the redundant database objects; and
populating a searchable knowledge graph including the second representations of the database objects and the relationships.
